(19) United States
(12) Patent Application Publication
(10) Pub. No.: US 2004/0149116 A1
(43) Pub. Date: Aug. 5, 2004

(54) Device for sawing apart two-up book blocks

(76) Inventor: Dieter Jahn, Machern (DE)

Correspondence Address: ALIX YALE & RISTAS LLP, 750 MAIN STREET, SUITE 1400, HARTFORD, CT, 06103, US

(21) Appl. No.: 10/755,600

(22) Filed: Jan. 12, 2004

(30) Foreign Application Priority Data
Jan. 21, 2003 (DE) 103 02 066.7

(51) Int. Cl. B26D 7/02

(52) U.S. Cl. 83/863; 83/466.1

(57) ABSTRACT

In a device for sawing apart two-up blocks (5) of adhesively bound or thread-stitched book blocks and brochures (6a, b), said device having a conveying apparatus for continuously transporting the two-up blocks and the cut-apart book blocks or brochures, which apparatus includes two or more plate-chain conveyers (9a, b) which are disposed side by side, carry the two-up blocks and, optionally, grip behind the latter with the aid of entrainment means (10), and of associated upper pressure-applying belts (12a, b), and said device having a circular saw blade (16) which is driven in a manner rotating in the same direction as the direction of conveyance of the two-up blocks and the axis of rotation of which is disposed above the plane of conveyance of said two-up blocks, an almost smooth separation at high processing speeds is achieved by providing a scoring tool (13) for the underside of the two-up blocks (5) disposed in front of the circular saw blade (16) for the purpose of scoring into the underside with at least one left-hand and one right-hand scoring line, which scoring lines are each at a distance of only a few tenths of a millimetre from the separating saw cut.

### BACKGROUND OF THE INVENTION

The present invention relates to a device for sawing apart two-up blocks of adhesively bound or thread-stitched book blocks or brochures.

The processing, for bookbinding purposes, of printed products is divided into various partial processes. In the block-production partial process, the collecting and assembling of the block are followed by the cutting-on-the block portion of the process. In the latter, the book block or brochure is given a three-sided, smooth trim on the edges which are not bound. In the process, the closed sides of the folded sheets are opened so that it is possible to turn to each individual page of the block. In order to increase the output of the collecting and assembling portions of the process, the book blocks or brochures are sometimes produced in the form of so-called “two-up blocks”. In that case, a block is produced which has two book blocks or brochures of the same kind which are disposed either foot-to-head or else head-to-head or foot-to-foot in the two-up block. Separation of the two-up blocks into two individual blocks then takes place first, before the cutting of the three sides.

A device in which the two-up blocks are guided past a band saw, with the aid of which the separation into individual blocks is performed, is represented, by way of an example, in U.S. Pat. No. 2,822,003. The relatively low speed of the saw blade permits only low separating outputs. Moreover, the replacement of worn saw blades is expensive.

In process lines in which book blocks or brochures are collected, assembled and trimmed in a continuous flow, separating saws (for example separating saw TR 160, available from Kolbus GmbH & Co. KG, Rahden, Germany) having saw blades that are driven in a rotating manner are used for separating the two-up blocks. In this case, the two-up blocks pass into a magazine, from which the lowest two-up blocks in each case is isolated and pushed out, spine first, for transfer to two plate-chain conveyers which are disposed side by side and have entrainment means that grip behind the two-up blocks. During the continuous transporting operation, the two-up blocks, which rest against the entrainment means with their face cut, are aligned laterally against a fixed edge via drag springs and held securely on the plate-chain conveyers by upper pressure-applying belts. Separation takes place with the aid of a circular saw blade which is disposed between the plate-chain conveyers, is located with its axis of rotation above the plane of conveyance of the two-up blocks and rotates in the same direction as the direction of conveyance and with which an interchangeable counter-plate provided with an incision is associated, between the plate chains, as a counter-knife-edge.

The incision in the plate becomes wider because of vibrations of the circular saw blade that occur and as a result of shavings abrasion, and the counter-knife-edge for the circular saw blade no longer has a sharp construction, with the consequence that, in the course of the separating cut, the saw teeth of the circular saw blade tear out splinters and the like when the blade runs out on the underside of the two-up block. In the process, the cover, in particular, of the brochures is damaged by split-off portions and tears which can be eliminated only by a generally unwelcome, major trimming operation in the three-cutter machine and which entail frequent changing of the counter-knife-edge. Under these circumstances, the problems that have been pointed out increase in proportion to the speed of processing.

### SUMMARY OF THE INVENTION

The object of the invention is to provide an improve device for sawing apart two-up blocks of adhesively bound or thread-stitched book blocks or brochures, whereby an almost smooth separation is made possible at high processing speeds.

The object of the invention is achieved, in a surprisingly simple and economic manner, by a scoring tool for the underside of the two-up blocks, disposed in front of the main separating saw blade, for the purpose of scoring into the underside with at least one left-hand and one right-hand scoring line. The scoring lines are each at a distance of only a few tenths of a millimetre from the separating saw cut.

With the aid of the scoring operation into the underside of the two-up block, the run-out of the circular saw blade is shifted into the interior of the book block or brochure. Scoring lines even a few tenths of a millimetre deep on the left and right of the actual separating saw cut are sufficient to offer that last sheet of the two-up block which is to be severed by the circular saw blade an adequate abutment for the separating cut because of the sheets that lie underneath and have been scored into. A counter-knife-edge is no longer necessary. The tears turn out to be substantially smaller and a trimming operation only a few millimetres wide in the three-cutter machine is sufficient to bring about smooth edges on the finish-trimmed book block or brochure. With the aid of the sawing-apart operation according to the invention, a smooth cutting line without any tears is imparted to the cover, in particular, of the brochure.

The scoring-in operation preferably takes place with the aid of a two-row circular scoring knife which is driven in a rotating manner and which, in order to achieve the best scoring results, is driven in the same direction as the direction of conveyance. By this means, a shavings-free pre-scoring operation takes place. This, on the one hand, is non-damaging to the spine of the two-up block and, on the other hand, requires no expensive extraction of shavings.

Preferably, the circular scoring knife is formed from two knife blades which are clamped to one another, it being possible to set the distance between them, and thereby the cutting width of said circular scoring knife, by means of intermediate pieces. In a preferred form, the knife blades present at their periphery, a large number of individual knife edges which are separated from one another by a cut-out portion and have a cutting line inclined with respect to the circle of flight of the knife blades, in such a way that a rising cutting line is produced in the course of the scoring-in operation. This results in a draw cut which leads to a cut which is of superior quality.

The preferred cutting width of the scoring tool is about 0.2 to 1 mm wider than the separating saw cut. On the one hand, satisfactory separating-cut results are achieved by this means and, on the other hand, a high constructional outlay is not required in order to achieve the necessary accuracies of alignment. In order to position the scoring tool centrally in relation to the circular saw blade, adjustment of said scoring tool transversely to the direction of conveyance of the two-up blocks is expedient. The scoring tool is advantageously adjustable in height for the purpose of setting a specific scoring depth and for the purpose of bringing said scoring tool out of engagement.

In the case of thin products which have only low degrees of stiffness in regions remote from the bound spine, a holding-down rail which acts on the upper side of the two-up blocks in the region of the scoring tool for the purpose of guaranteeing a constant scoring depth is advantageous. For the same reason, a counterplate is provided between the plate chains for the purpose of supporting the two-up block in the course of the separating cut with the aid of the circular saw blade. In this connection, the incision for the passage of the circular saw blade is wider than the cutting width of the scoring tool. As a result of this, the saw shavings are carried out of the two-up block without obstruction.

### BRIEF DESCRIPTION OF THE DRAWINGS T

he preferred embodiment of invention will be explained in greater detail below with reference to the accompanying drawings, in which:

FIG. 1 shows a separating saw according to the invention in a simplified perspective view; and

FIG. 2 shows a detail of the separating saw in the region of the separating station.

### DESCRIPTION OF THE PREFERRED EMBODIMENT

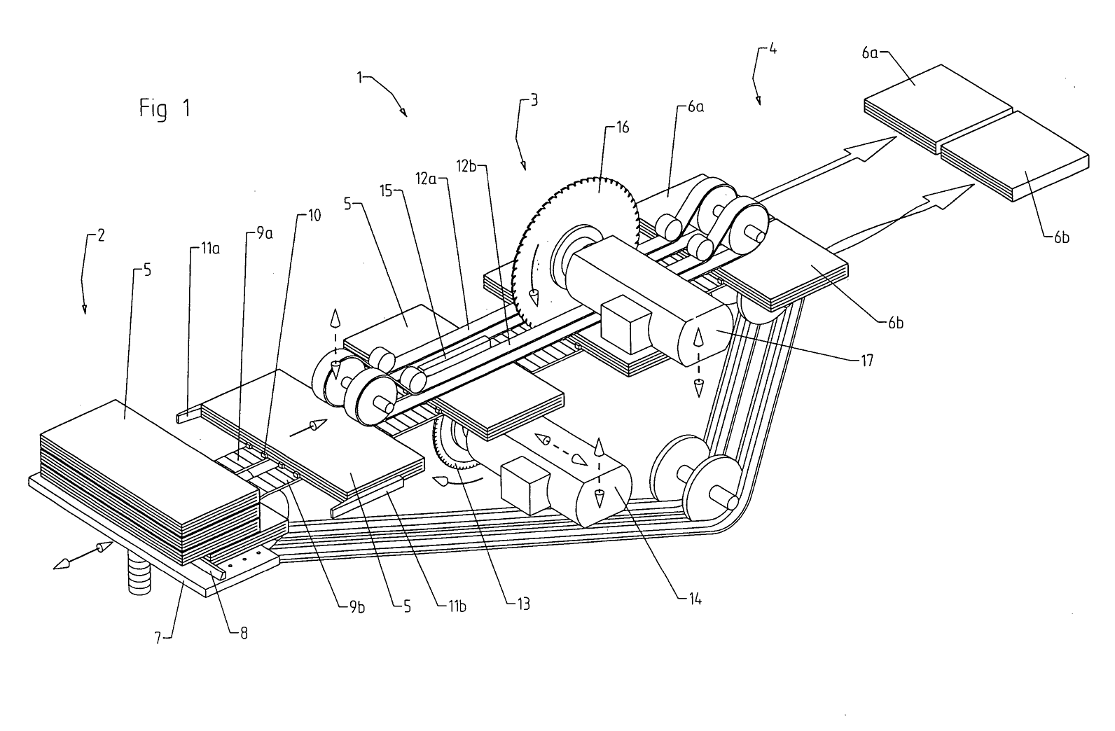

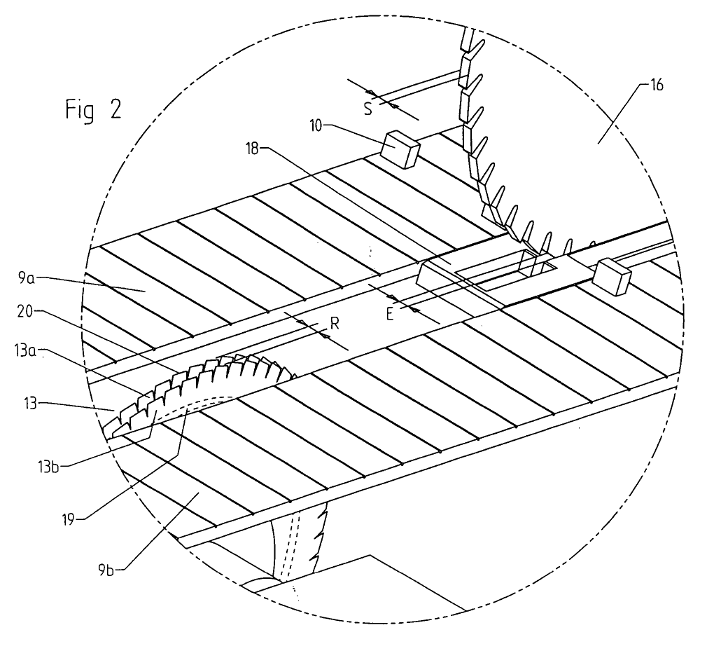

With reference to FIGS. 1 and 2, the separating saw 1 according to the invention comprises a magazine 2, a separating station 3 and a feeding-out system 4. The book blocks or brochures which have been produced in the form of two-up blocks 5 pass, via a transport path which is not represented here, into the magazine 2 which is symbolised in FIG. 1 by the stacked arrangement of a number of two-up blocks 5. With the aid of a suction-type sliding table 7, which is moved forward and back, the bottom two-up block 5 in each case is pushed, spine first, out of the magazine 2 during the forward stroke by the force-locking entrainment of the suction air acting on the underside of said two-up block 5 and, in addition, by the form-locking entrainment of entrainment means 8 acting on the front cut of the two-up block 5 and, in the process, is transferred onto continuously running plate-chain conveyers 9a, 9b as a result of a change-over from suction air to blown air. The conveyors are preferably in the form of a pair of parallel, spaced apart bands. The blown air also remains connected during the return stroke of the suction-type sliding table 7.

Entrainment means 10 fastened on the plate-chain conveyers 9a, 9b align the two-up block 5 isolated from the magazine 2 via its front cut and permit the form-locking entrainment of said two-up block 5 during the separating operation. The two-up block 5 is additionally aligned transversely to the direction of conveyance by guide rails 11a, 11b which act laterally on said two-up block 5. The latter then runs into upper pressure-applying belts 12a, 12b which, in addition to the entrainment means 10 that act in a form-locking manner, hold the two-up block 5 on the plate-chain conveyers 9a, 9b in a force-locking manner. The pressure-applying belts 12a, 12b can be set vertically to the thickness of the book blocks or brochures.

The two-up block 5, which is now transported forwards toward the separating saw 16 in the firmly clamped-in condition, is first of all pre-scored, by a circular scoring knife 13 which is disposed underneath the plane of conveyance and is formed from two corotating, spaced knife blades 13a, 13b clamped to one another, for scoring two parallel lines running in the conveying direction. The distance between the knife blades is indicated as a cutting width R in FIG. 2 and can be set by an interchangeable or adjustable intermediate shim piece 19. The circular scoring knife 13 is directly coupled to a motor 14 and rotates in the direction represented in FIG. 1, the same direction as the direction of conveyance. In the case of thin products, which have only low degrees of stiffness in regions remote from the bound spine, a holding-down rail 15 is provided which acts on the upper side of the two-up blocks 5 between the pressure-applying belts 12a, b in the region of and in opposition to the circular scoring knife 13 for the purpose of guaranteeing a constant scoring depth in the underside of said two-up blocks 5. The circular scoring knife 13, together with the appertaining motor 14, can be adjusted transversely to the direction of conveyance for the purpose of positioning the scoring lines. A height-adjusting system is also provided for the purpose of setting a specific scoring depth or for the purpose of bringing the circular scoring knife 13 out of engagement.

The knife blades 13a, b have, at the periphery, a large number of individual knife edges 20 which are separated from one another by a cut-out portion and the cutting line of which is inclined with respect to the circle of flight of said knife blades 13a, b in such a way that a rising cutting line is produced in the course of the scoring-in operation in order to perform a draw cut. The scoring-in operation takes place in a shavings-free manner.

After the pre-scoring operation, the two-up blocks 5 arrive at a circular saw blade 16 which is driven in a manner rotating in the same direction as the direction of conveyance of the two-up blocks 5, and the axis of rotation of which is disposed above the plane of conveyance of said two-up blocks 5. The circular saw blade 16 is directly coupled to a motor 17 and can be set vertically by means, no further details of which are represented. The separating cut which thereby takes place is a material-detaching one and is preferably located precisely in the middle between the two scoring lines, the cutting breadth R of the circular scoring knife 13 being about 0.2 to 1 mm wider than the cutting width S of the circular saw blade 16.

Associated with the circular saw blade 16 is a counterplate 18 which is disposed between the plate-chain conveyers 9a, b and serves to support the two-up block 5 in the course of the separating cut with the aid of said circular saw blade 16. For the passage of the circular saw blade 16, the counterplate 18 is provided with an incision, the width E of which is about 1 to 2 mm wider than the cutting width R of the scoring tool 13. As a result of this, the saw shavings are carried out of the two-up block 5 without obstruction. The counterplate 18 is provided with additional apertures alongside, before and after the passage for the purpose of extracting the saw shavings occurring between the plate-chain conveyers 9a, b.

As a rule, the two-up block 5 consists of book blocks or brochures 6a, 6b which are disposed head-to-head or foot-to-foot. In the feeding-out system 4, one of the two book blocks or brochures 6a, 6b that have been separated from one another is then re-orientated in such a way that two book blocks or brochures 6a, 6b that are orientated in the same way are fed to the subsequent three-cutter machine. In FIG. 1, the turning of the right-hand book block or brochure 6b is represented symbolically by a twisted arrow. The turning operation takes place, for example, with the aid of known turning belts which clamp the book block or brochure 6b in a force-locking manner. The separated book blocks or brochures 6a, 6b leave the separating saw 1 in a double stream and are fed to a three-cutter machine as a result of a transverse transfer, which is not represented here, onto an onward conveyer.

In the exemplified embodiment, the two-up blocks 5 are transported spine first. This is advantageous because the isolation from the magazine 2 thereby takes place without pushing-up of the open sides, and transport from said magazine 2 through the separating station 3 and right through the feeding-out system 4 is possible in a simple and secure manner without additional means for holding down the sides which would otherwise be open in the direction of running. The invention also includes the use of the circular scoring knife 13 according to the invention in the separation of two-up blocks 5 which are transported with the front cut foremost.

1. Device for sawing apart two-up blocks of adhesively bound or thread-stitched book blocks and brochures, said device having a conveying apparatus for continuously transporting the two-up blocks and the cut-apart book blocks or brochures in a conveying direction on a plane of conveyance by means of side-by-side plate-chain conveyers for carrying the two-up blocks and associated side-by side upper pressure-applying belts for holding the two-up blocks down against the plate chain, and said device having a circular saw blade which is driven in a manner rotating in the same direction as the direction of conveyance of the two-up blocks and the axis of rotation of which is disposed above the plane of conveyance of said two-up blocks, said saw blade having a cutting width (S) through the two-up blocks, wherein the improvement comprises a scoring tool for the underside of the two-up blocks disposed upstream of the circular saw blade for scoring into the underside with at least one left-hand and one right-hand laterally spaced scoring lines, which scoring lines are each at a distance of only a few tenths of a millimetre from the separating saw cut.

2. Device according to claim 1, wherein the scoring tool is a rotatable, two-row circular scoring knife.

3. Device according to claim 2, wherein the circular scoring knife is driven in the same direction as the direction of conveyance.

4. Device according to claim 2, wherein the circular scoring knife is formed from two knife blades which are clamped to one another in spaced relationship by means of an interchangeable intermediate shim piece for setting the distance between them, and thereby setting a cutting width (R) defining the left and right scoring lines of said circular scoring knife.

5. Device according to claim 4, wherein rotation of the scoring tool produces a circle of flight of the knife blades and the knife blades present, at said circle of flight, a multiplicity of individual knife edges which are separated from one another by a cut-out portion and have a cutting line inclined with respect to knife blades, in such a way that a rising cutting line is produced in the course of the scoring-in operation.

6. Device according to claim 1, wherein the left and right hand scoring lines are produced by a cutting width (R) of the scoring tool that is about 0.2 to 1 mm wider than the cutting width (S) of the circular saw blade.

7. Device according to claim 1, wherein the scoring tool is adjustable transversely to the direction of conveyance of the two-up blocks.

8. Device according to claim 1, wherein the scoring tool is adjustable in height for the purpose of setting a specific scoring depth and for the purpose of bringing the scoring tool itself out of engagement.

9. Device according to claim 1, including a holding-down rail acting on the upper side of the two-up blocks during the scoring operation of the scoring tool.

10. Device according to claim 1, including a counterplate associated with the circular saw blade between the plate-chain conveyers for supporting the two-up blocks in the course of the separating cut, and which has an incision (E), which is wider than the lateral space between the scoring lines, for the passage of the circular saw blade, and additional apertures alongside, before and after the passage for the purpose of extracting the saw shavings occurring between the plate-chain conveyers.

11. Device for sawing apart two-up blocks of books or brochures, comprising:
conveying means for continuously transporting the two-up blocks in a conveying direction along a plane of conveyance, which conveying means includes parallel spaced apart conveyor bands for carrying the two-up blocks to a separating blade which passes between the conveyor bands;
said separating blade formed as a circular saw blade having a cutting width (S), which is rotated in the same direction as the direction of conveyance of the two-up blocks and the axis of rotation of which is disposed above the plane of conveyance of said two-up blocks; and
a scoring tool for the underside of the two-up blocks, disposed upstream of the circular saw blade between the spaced apart bands, for scoring parallel lines into the underside of the blocks while the blocks are conveyed toward the saw blade, the scoring lines running in the direction of conveyance and spaced apart by a distance that is greater than the saw cut width (S).

12. Device according to claim 11, wherein the scoring tool is a rotatable two-row circular scoring knife.

13. Device according to claim 12, wherein the circular scoring knife is rotated in the same direction as the direction of conveyance.

14. Device according to claim 12, wherein the circular scoring knife is formed from two spaced apart, corotating knife blades which define a cutting width (R) for cutting the scoring lines at said spaced apart distance.

15. Device according to claim 14, wherein rotation of the scoring tool produces a circle of flight of the knife blades and the knife blades present, at said circle of flight, a multiplicity of individual knife edges which are separated from one another by a cut-out portion and have a cutting line inclined with respect to knife blades, in such a way that a rising cutting line is produced in the course of the scoring-in operation.

16. Device according to claim 14, wherein the cutting width (R) of the scoring tool is about 0.2 to 1 mm wider than the cutting width (S) of the circular saw blade.

17. Device according to claim 11, wherein the scoring tool is adjustable transversely to the direction of conveyance of the two-up blocks.

18. Device according to claim 11, wherein the scoring tool is adjustable in height for the purpose of setting a specific scoring depth and for the purpose of bringing the scoring tool itself out of engagement with the block.

19. Device according to claim 11, including a holding-down rail acting on the upper side of the two-up blocks, in opposition to the scoring tool.

20. Device according to claim 11, including a counterplate associated with the circular saw blade between the conveyor bands for supporting the two-up blocks in the course of the separating cut, and which has an incision (E), which is wider than the distance between the scoring lines, for the passage of the circular saw blade, and additional apertures alongside, before and after the passage for the purpose of extracting the saw shavings occurring between conveyor bands.
